(19) United States
(12) Patent Application Publication
(10) Pub. No.: US 2021/0229681 A1
(43) Pub. Date: Jul. 29, 2021

(54) REALTIME PROACTIVE OBJECT FUSION FOR OBJECT TRACKING

(71) Applicant: GM GLOBAL TECHNOLOGY OPERATIONS LLC, Detroit, MI (US)

(72) Inventors: Paul A. Adam, Milford, MI (US); Dmitriy Feldman, West Bloomfield, MI (US); Gabriel T. Choi, Novi, MI (US); Xiaofeng F. Song, Novi, MI (US); Julius M. Vida, Brighton, MI (US)

(73) Assignee: GM GLOBAL TECHNOLOGY OPERATIONS LLC, Detroit, MI (US)

(21) Appl. No.: 16/773,087

(22) Filed: Jan. 27, 2020

(51) Int. Cl. B60W 50/00; G05D 1/00; G01S 17/66; G01S 15/66; G01S 13/66

(52) U.S. Cl. CPC B60W 50/00; G05D 1/0088; G01S 17/66; B60W 60/00; G01S 13/66; G05D 2201/0213; G01S 15/66

(57) ABSTRACT

Systems and methods are provided for tracking objects in an autonomous vehicle having multiple sensors. A method includes: determining, by a processor, a type of an environmental condition associated with the autonomous vehicle; adjusting, by the processor, a weight associated with a first type of sensor of the multiple sensors in response to the type of the environmental condition; fusing, by the processor, sensor data from the multiple sensors based on the adjusted weight; tracking, by the processor, an object in the environment of the autonomous vehicle based on the fused sensor data; and controlling, by the processor, the autonomous vehicle based on the tracked object.

### INTRODUCTION

The present disclosure generally relates to autonomous vehicles, and more particularly relates to systems and methods for fusing object data from multiple sensors of an autonomous vehicle based on environmental conditions in order to provide improved tracking of the objects.

An autonomous vehicle is a vehicle that is capable of sensing its environment and navigating with little or no user input. An autonomous vehicle senses its environment using sensing devices such as radar, lidar, image sensors such as cameras, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicle systems, such systems might still be improved in a number of respects. For example, object tracking performance degrades when environmental conditions such as snow, rain, fog, or rapidly changing conditions occur due to poor sensor and/or recognition performance. Accordingly, it is desirable to provide improved systems and methods for tracking objects during these weather conditions. It is further desirable to provide systems and methods for recalibrating the camera system in realtime. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for tracking objects in an autonomous vehicle having multiple sensors. A method includes: determining, by a processor, a type of an environmental condition associated with the autonomous vehicle; adjusting, by the processor, a weight associated with a first type of sensor of the multiple sensors in response to the type of the environmental condition; fusing, by the processor, sensor data from the multiple sensors based on the adjusted weight; tracking, by the processor, an object in the environment of the autonomous vehicle based on the fused sensor data; and controlling, by the processor, the autonomous vehicle based on the tracked object.

In various embodiments, the weight is adjusted based on a type of a weather condition. In various embodiments, the type of the weather condition includes at least one of rain, snow, fog, and sun glare.

In various embodiments, the adjusting the weight includes adjusting a weight associated with a group of sensors of the multiple sensors. In various embodiments, the group includes at least one of a group of lidar sensors, a group of ultrasonic sensors, a group of radar sensors, and a group of camera sensors.

In various embodiments, the adjusting is based on:

$${s}^{2} = envGateWeight * max ( 1 , \frac{initWeigh t}{numOfCycles} ) ,$$

where initWeight refers to an initial weight, and numOfCycles refers to a total time the object has been alive.

In various embodiments, the method includes selecting a filter coefficient based on the type of the environmental condition. In various embodiments, the filter coefficient is a Kalman filter coefficient used in at least one of prediction and correction.

In various embodiments, the selecting the filter coefficient is based on:

$${d}_{k} = {{[ \begin{matrix}{e}_{x , k} \\ {e}_{y , k}\end{matrix} ]}^{T} [ \begin{matrix}{σ}_{x}^{2} e nvWx & {σ}_{x y} e nvWxy \\ {σ}_{x y} e nvWxy & {σ}_{y}^{2} e nvWy\end{matrix} ]}^{- 1} [ \begin{matrix}{e}_{x , k} \\ {e}_{y , k}\end{matrix} ] ,$$

where σₓ² refers to covariance associated with longitudinal position error, σ_{y}² refers to covariance associated with lateral position error, σ_{xy} refers to covariance associated with diagonal error in position measurement, envWx refers to an environmental weight assigned to track for longitudinal position error, envWy refers to an environmental weight assigned to track for lateral position error, and envWxy refers to an environmental weight assigned to track for correlated xy position error.

In various embodiments, the method includes selectively rejecting sensor data from a single sensor of the multiple sensors based on the type of environmental condition.

In another embodiments, a system includes: a data storage device that stores a plurality of weights, each weight is associated with a type of environmental condition and a type of a sensor; and a control module configured to, by a processor, determine a type of an environmental condition associated with the autonomous vehicle, adjust a weight associated with a first type of sensor of the multiple sensors in response to the determined type of the environmental condition based on the plurality of stored weights, fuse sensor data from the multiple sensors based on the adjusted weight, track an object in the environment of the autonomous vehicle based on the fused sensor data, and control the autonomous vehicle based on the tracked object.

In various embodiments, the environmental condition includes a weather condition.

In various embodiments, the control module adjusts the weight by adjusting a weight associated with a group of sensors of the multiple sensors. In various embodiments, the group includes at least one of a group of lidar sensors, a group of ultrasonic sensors, a group of radar sensors, and a group of camera sensors of the multiple sensors.

In various embodiments, the adjusting is based on:

$${s}^{2} = envGateWeight * max ( 1 , \frac{initWeigh t}{numOfCycles} ) ,$$

where initWeight refers to an initial weight, and numOfCycles refers to a total time the object has been alive.

In various embodiments, the control module is further configured to select a filter coefficient based on the type of the environmental condition. In various embodiments, the filter coefficient is a Kalman filter coefficient used in at least one of prediction and correction. In various embodiments, the control module selects the filter coefficient based on:

$${d}_{k} = {{[ \begin{matrix}{e}_{x , k} \\ {e}_{y , k}\end{matrix} ]}^{T} [ \begin{matrix}{σ}_{x}^{2} e nvWx & {σ}_{x y} e nvWxy \\ {σ}_{x y} e nvWxy & {σ}_{y}^{2} e nvWy\end{matrix} ]}^{- 1} [ \begin{matrix}{e}_{x , k} \\ {e}_{y , k}\end{matrix} ] ,$$

where σₓ² refers to covariance associated with longitudinal position error, σ_{y}² refers to covariance associated with lateral position error, σ_{xy} refers to covariance associated with diagonal error in position measurement, envWx refers to an environmental weight assigned to track for longitudinal position error, envWy refers to an environmental weight assigned to track for lateral position error, and envWxy refers to an environmental weight assigned to track for correlated xy position error.

In various embodiments, the control module is configured to selectively reject sensor data from a single sensor of the multiple sensors based on the type of environmental condition.

In still another embodiment, a vehicle includes: a plurality of sensors having a plurality of different sensor types; and a controller configured to, by a processor, determine a type of an environmental condition associated with the autonomous vehicle, adjust a weight associated with a first type of sensor of the multiple sensors in response to the type of the environmental condition, fuse sensor data from the multiple sensors based on the adjusted weight, track an object in the environment of the autonomous vehicle based on the fused sensor data, and control the autonomous vehicle based on the tracked object.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having an object tracking system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the object tracking system of the autonomous vehicle, in accordance with various embodiments; and

FIG. 5 is a flowchart illustrating a control method for object tracking and controlling the autonomous vehicle based thereon, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

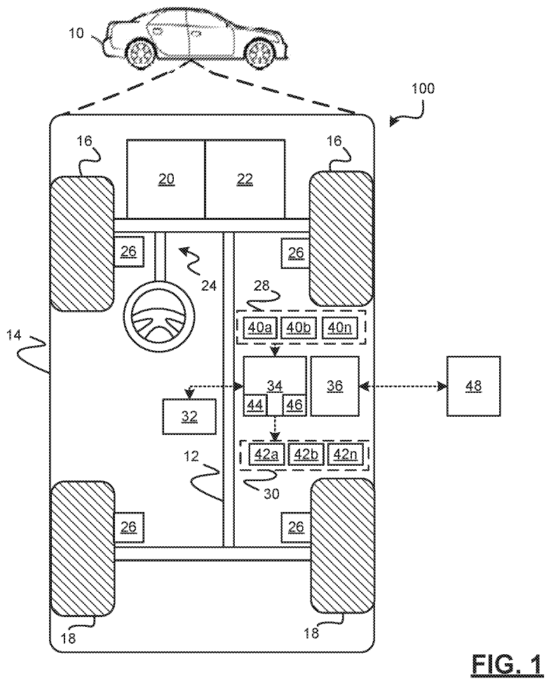

With reference to FIG. 1, an object tracking system shown generally at 100 is associated with a vehicle 10 in accordance with various embodiments. As will be discussed in more detail below, the object tracking system 100 dynamically adjusts weights and/or coefficients used in object data fusion methods that fuse object data from multiple sensors of the autonomous vehicle. In various embodiments, the object tracking system 100 dynamically adjusts sensor grouping weights or tracking weights of certain objects based on known environmental conditions. In various embodiments, the object tracking system further rejects certain sensor data from being used in the fusion process based on known environmental conditions. The adjustment of the weights and rejection of certain data improves the stability and persistence of existing fused objects and improves the accuracy of dynamic object attributes (i.e., velocity, position, acceleration, etc.)

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the object tracking system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. In various embodiments, some of the sensing devices 40a-40n are used for detecting objects in the environment of the autonomous vehicle 10. In various embodiments, some of the sensing devices 40a-40n are used for detecting environmental conditions of the environment of the autonomous vehicle 10.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

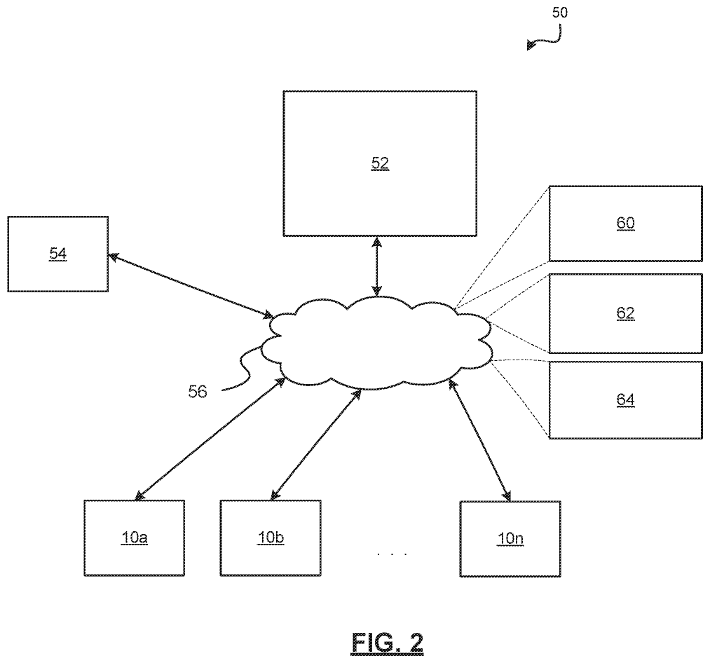

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the object tracking system 100 and, when executed by the processor 44, process data from the sensor system 28 in order to detect and track objects within the navigable environment of the autonomous vehicle 10. As will be discussed in more detail below, the one or more instructions process the data based on fusion methods and weights that are dynamically adjusted based on detected environmental conditions that may affect sensor information (e.g., rain, snow, fog, sun glare, etc.).

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

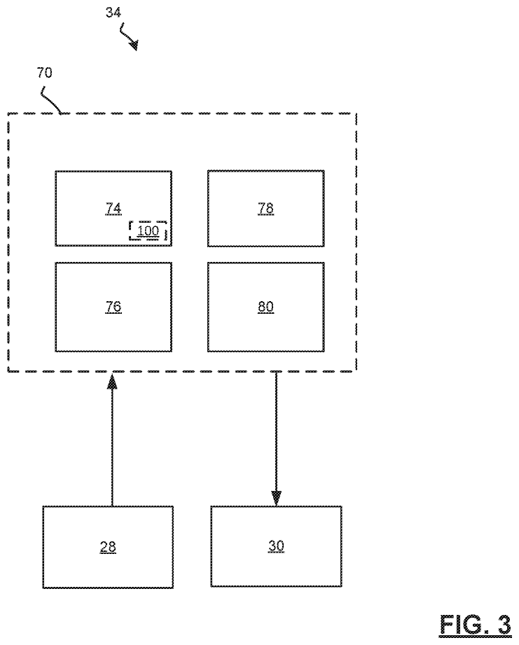

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from the multiple sensors of the sensor system 28, including but not limited to cameras, lidars, radars, and/or any number of other types of sensors. In various embodiments, the computer vision system 74 includes the object tracking system 100 of the present disclosure.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

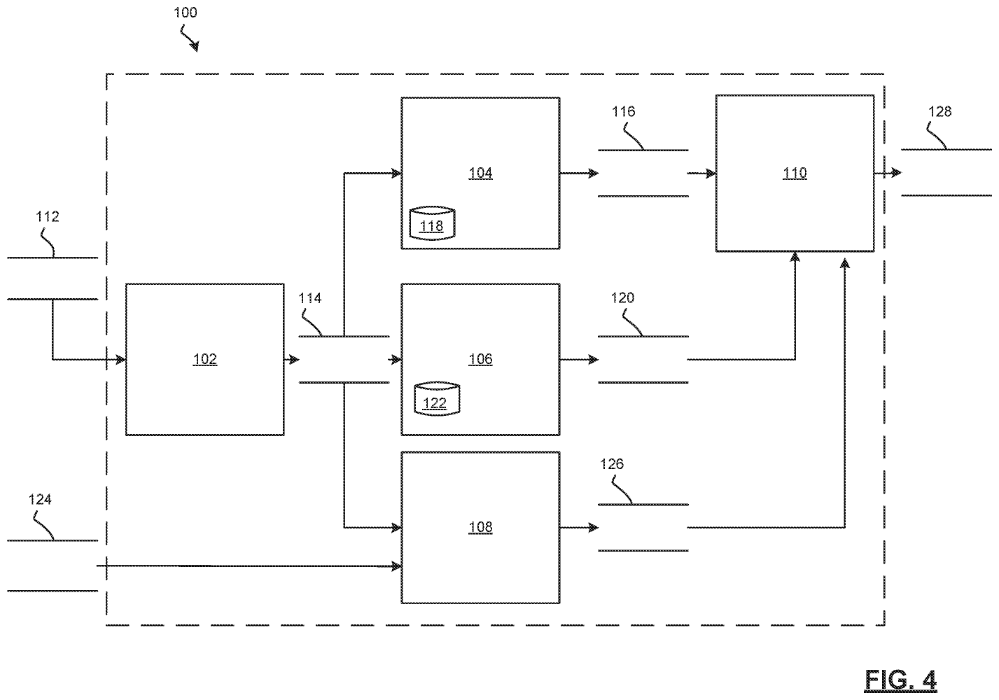

As mentioned briefly above, parts of object tracking system 100 of FIG. 1 are included within the ADS 70, for example, as part of the computer vision system 74 or as a separate system. For example, as shown in more detail with regard to FIG. 4 and with continued reference to FIGS. 1-3, the object tracking system 100 includes an environmental condition evaluation module 102, a weights adjustment module 104, a coefficients adjustment module 106, a sensor data rejection module 108, and a fusion module 110. As can be appreciated, various embodiments of the calibration system 100 according to the present disclosure can include any number of sub-modules. As can be appreciated, the sub-modules shown in FIG. 4 can be combined and/or further partitioned to similarly dynamically adjust weights used in fusing sensor data.

In various embodiments, the environmental condition evaluation module 102 receives environment data 112 indicative of weather conditions of the environment of the autonomous vehicle 10. Such data can include, but is not limited to, data from the sensor system 28, cloud sourced data, weather data from a remote system, or any other data indicative of conditions of the environment. The environmental condition evaluation module 102 processes the received environment data 112 to determine a current type of environmental condition or conditions 114. Such types of environmental conditions can include, but are not limited to, rain, fog, snow, sun glare, sleet, normal, etc. As can be appreciated, the environmental condition evaluation module 102 can determine the type 114 based on various condition detection methods and is not limited to any one method.

The weights adjustment module 104 receives the current type of environmental condition 114. The weights adjustment module 104 adjusts grouping weights 116 associated with individual sensor or groups of sensors of the sensor system 28 based on the current type of environmental condition 114. For example, weights may be predefined and stored in a weights datastore 118. Each of the weights are associated with a sensor type (e.g., lidar, radar, ultrasonic, camera, etc.) and an environmental condition (e.g., rain, fog, snow, sun glare, normal, etc.). When the current type of environmental condition 114 indicates a type that affects sensor information such as rain, fog, snow, sun glare, etc., weights that correspond to the current type of environmental condition are retrieved for each sensor type or group of sensors from the weights datastore 118. Weights are then computed for each sensor or sensor group based on the retrieved weight (envGateWeight) and the following relation:

$${s}^{2} = envGateWeight * max ( 1 , \frac{initWeigh t}{numOfCycles} ) ,$$

where initWeight refers to the initial weight and numOfCycles refers to the total time the object has been alive (e.g., time=number of cycles*a periodic rate).

When the current type of environmental condition indicates a type that does not affect sensor information such as normal weather, nominal weights are retrieved for each sensor type or group of sensors from the weights datastore 118.

The coefficients adjustment module 106 receives the current type of environmental condition 114. The coefficients adjustment module 106 adjusts coefficients 120 used in prediction and correction of object tracking based on the current type of environmental condition 114. In various embodiments, the coefficients are Kalman coefficients used in prediction and correction. For example, a plurality of coefficients may be predefined and stored in a coefficients datastore 122. Each of the coefficients are associated with an environmental condition (e.g., rain, fog, snow, sun glare, normal, etc.). When the current type of environmental condition 114 indicates a type that affects sensor information such as rain, fog, snow, sun glare, coefficients that correspond to the current type of environmental condition are retrieved from the coefficients datastore 122. Coefficients are then computed based on the retrieved coefficients and the following relation:

$${d}_{k} = {{[ \begin{matrix}{e}_{x , k} \\ {e}_{y , k}\end{matrix} ]}^{T} [ \begin{matrix}{σ}_{x}^{2} e nvWx & {σ}_{x y} e nvWxy \\ {σ}_{x y} e nvWxy & {σ}_{y}^{2} e nvWy\end{matrix} ]}^{- 1} [ \begin{matrix}{e}_{x , k} \\ {e}_{y , k}\end{matrix} ] ,$$

where σₓ² refers to the covariance associated with longitudinal position error, σ_{y}² refers to covariance associated with lateral position error, σ_{xy} refers to covariance associated with “diagonal” error in position measurement (correlation between x and y). Where e_{x,k}:=xₘₑₐₛ−xₖ, and e_{y,k}:=yₘₑₐₛ−yₖ. envWx refers to an environmental weight assigned to track for longitudinal position error, envWy refers to an environmental weight assigned to track for lateral position error, and envWxy refers to an environmental weight assigned to track for correlated xy position error. The environmental weights are assigned by establishing a priori trough a benchmarking process typical error under given environmental conditions.

When the current type of environmental condition 114 indicates a type that does not affect sensor information such as normal weather, nominal coefficients are retrieved from the coefficients datastore 122.

The sensor data rejection module 108 receives the current type of environmental condition 114, and sensor data 124 from the sensor system 28. The sensor data rejection module 108 evaluates the data from each of the sensors individually based on a standard deviation envelope associated with the current type of environmental condition 114. When the individual sensor data is outside of the standard deviation envelope associated with the current environmental condition, the individual sensor data is rejected from use in the fusion process. When the individual sensor data is within the standard deviation envelope associated with the current environmental condition, the individual sensor data is accepted for use in the fusion process. The collection of the accepted sensor data 126 is then made available for fusion.

The sensor data fusion module 110 receives the accepted sensor data 126, the weights 116, and the coefficients 120. The sensor data fusion module 110 fuses the accepted sensor data 126 into a single point cloud of data based on the weights 116, the coefficients 120, and fusion methods. As can be appreciated, various fusion methods using weights and/or coefficients may be used as the sensor data fusion module 110 is not limited to any one method. The fused data 128 is then made available for object tracking and control of the autonomous vehicle 10 based thereon.

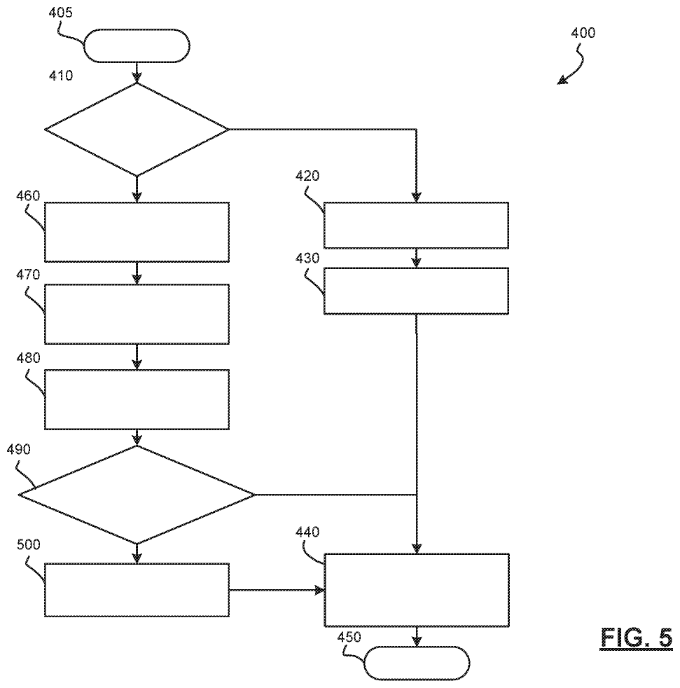

Referring now to FIG. 5, and with continued reference to FIGS. 1-4, a flowchart illustrates a control method 400 that can be performed by the object tracking system 100 of FIGS. 1 and 4 in accordance with the present disclosure. As can be appreciated in light of the disclosure, the order of operation within the method is not limited to the sequential execution as illustrated in FIG. 5 but may be performed in one or more varying orders as applicable and in accordance with the present disclosure. In various embodiments, the method 400 can be scheduled to run based on one or more predetermined events, and/or can run continuously during operation of the autonomous vehicle 10.

In one example, the method may begin at 405. It is determined an environmental condition that affects sensor information exists at 410, for example, as discussed above.

If an environmental condition that affects sensor information exists at 410, the method continues with selecting nominal grouping and/or tracking weights at 420 and selecting nominal filter coefficients at 430. Thereafter, the selected nominal weights and the selected nominal filter coefficients are used in the processes of fusing data from multiple sensors of the sensor system in order to track objects at 440 and control the autonomous vehicle 10. Thereafter, the method may end at 450.

If, however, environmental conditions that affect sensor information exist at 410, the fusion grouping weights are adjusted to the observed environmental condition or conditions at 460, for example, as discussed above. Thereafter, the filter coefficients are selected for Kalman prediction and correction based on the observed environmental condition or conditions at 470, for example, as discussed above.

Thereafter, the standard deviation (STD) envelope is determined for the current type of environmental condition at 480 and evaluated at 490. For example, it is determined whether all the individual sensor data fall within the custom standard deviation (STD) envelope for the observed environmental condition or conditions at 490.

If all the fused tracks are within the STD envelope at 490, the fused tracks are all accepted. Thereafter, the selected weights and the filter coefficients are used in the processes of fusing the accepted sensor data from the multiple sensors of the sensor system 28 in order to track objects at 440 and control the autonomous vehicle 10. Thereafter, the method may end at 450.

If one or more of the individual sensor data is outside of the STD envelope at 490, the individual sensor data is rejected at 500. Thereafter, the method continues with fusing only the accepted sensor data from the multiple sensors based on the grouped weights and/or the selected filter coefficients in order to track objects at 440 and control the autonomous vehicle 10. Thereafter, the method may end at 450.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of tracking objects in an autonomous vehicle having multiple sensors, comprising:
determining, by a processor, a type of an environmental condition associated with the autonomous vehicle;
adjusting, by the processor, a weight associated with a first type of sensor of the multiple sensors in response to the type of the environmental condition;
fusing, by the processor, sensor data from the multiple sensors based on the adjusted weight;
tracking, by the processor, an object in the environment of the autonomous vehicle based on the fused sensor data; and
controlling, by the processor, the autonomous vehicle based on the tracked object.

2. The method of claim 1, wherein the weight is adjusted based on a type of a weather condition.

3. The method of claim 2, wherein the type of the weather condition includes at least one of rain, snow, fog, and sun glare.

4. The method of claim 1, wherein the adjusting the weight comprises adjusting a weight associated with a group of sensors of the multiple sensors.

5. The method of claim 4, wherein the group comprises at least one of a group of lidar sensors, a group of ultrasonic sensors, a group of radar sensors, and a group of camera sensors.

6. The method of claim 1, wherein the adjusting is based on:
$${s}^{2} = envGateWeight * max ( 1 , \frac{initWeigh t}{numOfCycles} ) ,$$
where initWeight refers to an initial weight, and numOfCycles refers to a total time the object has been alive.

7. The method of claim 1, further comprising selecting a filter coefficient based on the type of the environmental condition.

8. The method of claim 7, wherein the filter coefficient is a Kalman filter coefficient used in at least one of prediction and correction.

9. The method of claim 7, wherein the selecting the filter coefficient is based on:
$${d}_{k} = {{[ \begin{matrix}{e}_{x , k} \\ {e}_{y , k}\end{matrix} ]}^{T} [ \begin{matrix}{σ}_{x}^{2} e nvWx & {σ}_{x y} e nvWxy \\ {σ}_{x y} e nvWxy & {σ}_{y}^{2} e nvWy\end{matrix} ]}^{- 1} [ \begin{matrix}{e}_{x , k} \\ {e}_{y , k}\end{matrix} ] ,$$
where σₓ² refers to covariance associated with longitudinal position error, σ_{y}² refers to covariance associated with lateral position error, σ_{xy} refers to covariance associated with diagonal error in position measurement, envWx refers to an environmental weight assigned to track for longitudinal position error, envWy refers to an environmental weight assigned to track for lateral position error, and envWxy refers to an environmental weight assigned to track for correlated xy position error.

10. The method of claim 1, further comprising selectively rejecting sensor data from a single sensor of the multiple sensors based on the type of environmental condition.

11. A system for tracking objects in an autonomous vehicle having multiple sensors, comprising:
a data storage device that stores a plurality of weights, each weight is associated with a type of environmental condition and a type of a sensor; and
a control module configured to, by a processor, determine a type of an environmental condition associated with the autonomous vehicle, adjust a weight associated with a first type of sensor of the multiple sensors in response to the determined type of the environmental condition based on the plurality of stored weights, fuse sensor data from the multiple sensors based on the adjusted weight, track an object in the environment of the autonomous vehicle based on the fused sensor data, and control the autonomous vehicle based on the tracked object.

12. The system of claim 11, wherein the environmental condition includes a weather condition.

13. The system of claim 11, wherein the control module adjusts the weight by adjusting a weight associated with a group of sensors of the multiple sensors.

14. The system of claim 13, wherein the group comprises at least one of a group of lidar sensors, a group of ultrasonic sensors, a group of radar sensors, and a group of camera sensors of the multiple sensors.

15. The system of claim 11, wherein the adjusting is based on:
$${s}^{2} = envGateWeight * max ( 1 , \frac{initWeigh t}{numOfCycles} ) ,$$
where initWeight refers to an initial weight, and numOfCycles refers to a total time the object has been alive.

16. The system of claim 11, wherein the control module is further configured to select a filter coefficient based on the type of the environmental condition.

17. The system of claim 16, wherein the filter coefficient is a Kalman filter coefficient used in at least one of prediction and correction.

18. The system of claim 16, wherein the control module selects the filter coefficient based on:
$${d}_{k} = {{[ \begin{matrix}{e}_{x , k} \\ {e}_{y , k}\end{matrix} ]}^{T} [ \begin{matrix}{σ}_{x}^{2} e nvWx & {σ}_{x y} e nvWxy \\ {σ}_{x y} e nvWxy & {σ}_{y}^{2} e nvWy\end{matrix} ]}^{- 1} [ \begin{matrix}{e}_{x , k} \\ {e}_{y , k}\end{matrix} ] ,$$
where σₓ² refers to covariance associated with longitudinal position error, σ_{y}² refers to covariance associated with lateral position error, σ_{xy} refers to covariance associated with diagonal error in position measurement, envWx refers to an environmental weight assigned to track for longitudinal position error, envWy refers to an environmental weight assigned to track for lateral position error, and envWxy refers to an environmental weight assigned to track for correlated xy position error.

19. The system of claim 11, wherein the control module is configured to selectively reject sensor data from a single sensor of the multiple sensors based on the type of environmental condition.

20. A vehicle, comprising:
a plurality of sensors having a plurality of different sensor types; and
a controller configured to, by a processor, determine a type of an environmental condition associated with the autonomous vehicle, adjust a weight associated with a first type of sensor of the multiple sensors in response to the type of the environmental condition, fuse sensor data from the multiple sensors based on the adjusted weight, track an object in the environment of the autonomous vehicle based on the fused sensor data, and control the autonomous vehicle based on the tracked object.
